(19) United States
(12) Patent Application Publication
(10) Pub. No.: US 2011/0261456 A1
(43) Pub. Date: Oct. 27, 2011

(54) POLARIZATION COUPLER

(76) Inventor: Volker Raab, Potsdam (DE)

(21) Appl. No.: 13/124,864

(22) PCT Filed: Oct. 20, 2009
(86) PCT No.: PCT/DE2009/001485

§ 371 Date: Jul. 11, 2011

(30) Foreign Application Priority Data
Oct. 20, 2008 (DE) 10 2008 052 475.1

(51) Int. Cl. G02B 5/30

(52) U.S. Cl. 359/489.08

(57) ABSTRACT

The invention comprises an assembly (a) by which two polarized beam sources (1) and (2) of different wavelength by means of polarizing beam splitters (5) can be superimposed. By means of a dispersively birefringent crystal (6) both beams are rectified to reconstitute the linear polarization.

If, as assumed in (b), the beam sources can react spectrally to feedback, an additional polarization filter (8) and a partially reflecting coating (9) can ensure that suitable wavelengths are established automatically.

This assembly can be scaled as depicted in (b). By help of further dispersively birefringent crystals (6) and birefringent displacers more beams can be combined into a single beam, eight sources in the given setup.

### TECHNICAL FIELD OF APPLICATION

The invention aims at increasing the power density of lasers and particularly semiconductor lasers by means of a new method of polarization coupling by which beams of different wavelengths are being superimposed.

### BACKGROUND AND PRIOR ART

Each laser consists of a laser active region, also called gain region, in which the supplied energy is converted by stimulated emission into coherent radiation. For this purpose a laser resonator is needed to ensure that a part of the emerging radiation is passed back into the gain region. Therefore, it contains at least one feedback element, typically a semitransparent mirror. This resonator determines—by its geometry and physical properties—the feedback characteristics of the laser light, in particular the spatial profile, the wavelength, bandwidth, and polarization. The estimated achievable characteristics depend on the gain material and the resonators and are usually inversely correlated with each other and the achievable output power. Improvements of one chosen parameter thus tend to lead to deterioration of others.

Of particular practical importance are semiconductor lasers, because they are very small, directly convert electrical energy into light, have a high efficiency, and can be manufactured by established techniques of semiconductor production technology and are, thus, inexpensive in large quantities. The resonator is integrated in tandem by reflective layers that are applied to the end faces and/or refractive index gratings that are incorporated epitaxially. Currently, the output power or the power density achievable is still too low for many exciting applications. This is because the light is generated in volumes that are significantly smaller than 1 mm³, and therefore lead to power densities which would destroy the component when increased further. Increasing the volume is no solution because then the modal selectivity decreases and as a result the beam quality deteriorates which keeps the power density approximately constant. Approaches to increase the selectivity by a substructured gain material (DE 43 38 606, DE 36 11 167) help very little.

A long-practiced approach to at least double the output power consists in the superposition of two orthogonal laser polarizations using a polarization beam splitter, whereby the resulting light becomes unpolarized.

It is known (eg WO 03/055018) that very compact external resonators can improve the beam quality of high power diode lasers at high average powers dramatically. Yet, several such lasers have to be operated simultaneously for even greater beam power. This usually significantly decreases the beam quality and the possibility to generate small foci. The achievable power density remains virtually constant.

To overcome this problem, Daneu et. al. (Opt. Lett., Vol 25, No. 6, pp. 405-407) and Sanchez-Rubio (U.S. Pat. No. 6,192,062) proposed spectral multiplexing. This is an approach that uses multiple laser sources that are operated each on a different wavelength, so that they can be superimposed spatially by a suitably chosen element, usually a grid. On this basis, there were more patent filings (eg, WO 03/036766, WO 20/02091077). These patents all have a central dispersive element (prism or grating) which splits the resonator in two. On one side of the element the various laser emissions are collinear, i.e. beam cross section and emission direction are almost identical. On the second side of the element, the different beams are spread out spatially by the dispersion, so that under each direction a separate laser of appropriate wavelength can be operated. In general, this comprises lasers, which have a feedback mirror on the common path, since this ensures that each gain region operates exactly on the proper wavelength, determined by the dispersion.

Common for these patents is the fact that the spectral distance of the wavelengths that are to be multiplexed is defined by the dispersion and the resonator geometry. The dispersion in terms of “wavelength per angle” has to be multiplied by the angle “emitter spacing divided by distance to dispersion element”. For a dense spectral multiplexing large setups result or for a given resonator footprint and dispersion a spectral step size of typically larger than 1 nm results for neighboring emitters. Furthermore it is well known that most highly dispersive gratings only have a low diffraction efficiency and/or spectral acceptance and/or low damage thresholds which makes a practical realization quite difficult.

In subsequent sections we explain that different arrangements are more advantageous. They make use of the dispersion of birefringent crystals where the birefringence depends on the wavelength. This is a similar way as used in the filter introduced by Lyot [http://en.wikipedia.org/wiki/Lyot filter] which is sometimes also used as a filter in single lasers. Using a setup with similarities to a Lyot-filter has been proposed in DE 101 22 010 A1. There the different wavelength channels are having equal rights and are driven with light of the suitable wavelength. Conceptually similar is application WO 2005/006057 A1 but it serves for the purpose of splitting a common beam into separate beams of different wavelengths.

U.S. Pat. No. 3,503,670 modifies this setup in such that single birefringent elements can be manipulated electrically for switching on and off single channels into a predefined output channel.

A modification of this setup is described in B. S. Tan, P. B. Phua, R. F. Wu “Spectral beam combining of Yb-doped fiber lasers using wavelength dependent polarization rotators and polarization beam combiners” (http://arxiv.org/abs/0710.3635, eprint arXiv:0710.3635 v1 [physics.optics], 2007). There, adjustable elements continuously shift the phase of the separate wavelengths. If this is set up behind an optical parametric oscillator (“OPO”), then the phase shift of signal and idler can be adjusted to optimize subsequent nonlinear processes.

U.S. Pat. No. 6,847,786 B2 and U.S. Pat. No. 6,611,342 B2 explain how a special arrangement of various elements in combination with one or more mirrors can reduce the total number of elements and/or their overall size. These publications have in common that the serve to superimpose multiple light sources on predefined optical paths if these sources (already) possess the correct wavelengths. Both publications do not elaborate on how the different wavelengths are achieved or generated or stabilized. A variation of a resonator-internal Lyot-filter is described in P. B. Phua “Coherent polarization locking with near-perfect combining efficiency” (OPTICS LETTERS, Vol. 31, No. 14, S. 2148-2150, 2006). Inside the resonator a half-wave plate and a quarter-wave plate constitute an adjustable beam splitter which mixes the light into and out of two arms of a Y-shaped resonator. As opposed to a “conventional” mode of operation of a Lyot-filter the dispersion is set to a value so that the light that returns from the feedback mirror is variably polarized elliptically. Therefore, it can be split by a polarization beam splitter into two components. Both possess the same wavelength. Consequently the invention deals with the coherent coupling of two gain media. If one of the arms fails then the whole resonator suffers a dramatic increase of losses usually resulting in a complete failure of the entire laser system.

### FORMULATION OF PROBLEM AND PRINCIPAL SOLUTION

The problem to be solved is to find setups which can efficiently superimpose laser beams of multiple different wavelengths with closest possible wavelength separation in such a way that they form a common output beam. Common output beam means that beam position, beam extensions, and beam divergences of all separate lasers are practically equal. At the same time typical problems that occur with diffraction gratings are to be avoided, namely low damage thresholds, low diffraction efficiency, and low dispersion.

The solution in principle consist in an exploitation of the wavelength dependence of birefringence. Due to this dispersion of birefringence, for example in Calcite, it is possible to build and employ phase retarders that operate as half-wave plates for some wavelengths and phase-neutral for others. This leads to a 90° rotation of the plane of polarization for the former and no change for the latter. Orthogonally polarized beams of corresponding wavelengths will thus be parallel polarized upon exit of the birefringent element. For suitably chosen thicknesses of the birefringent crystals this design can be cascaded multiple times to couple more than two beams. This principle can be applied “passively” by taking beams of correct wavelengths. This is equivalent to the “state of the art”. Really interesting is this procedure for an “active” coupling. In this novel concept the coupling elements are introduced into the laser resonators. They must have a common path for at least a part of all their different branches that are to be coupled. By means of the filter each gain medium is forced to oscillate on its matching wavelength. Therefore one can dispense with additional and independent feedback and control loops to stabilize the necessary wavelengths. In this case of coupling with feedback the filter acts as a regular Lyot-filter for each of the laser branches. The invention consists in setting up the filter in such a way that a single Lyot-filter is simultaneously forcing a multitude of lasers onto different wavelengths which have spatially separated gain media but a common outcoupling path.

### DETAILED DESCRIPTION OF INVENTION

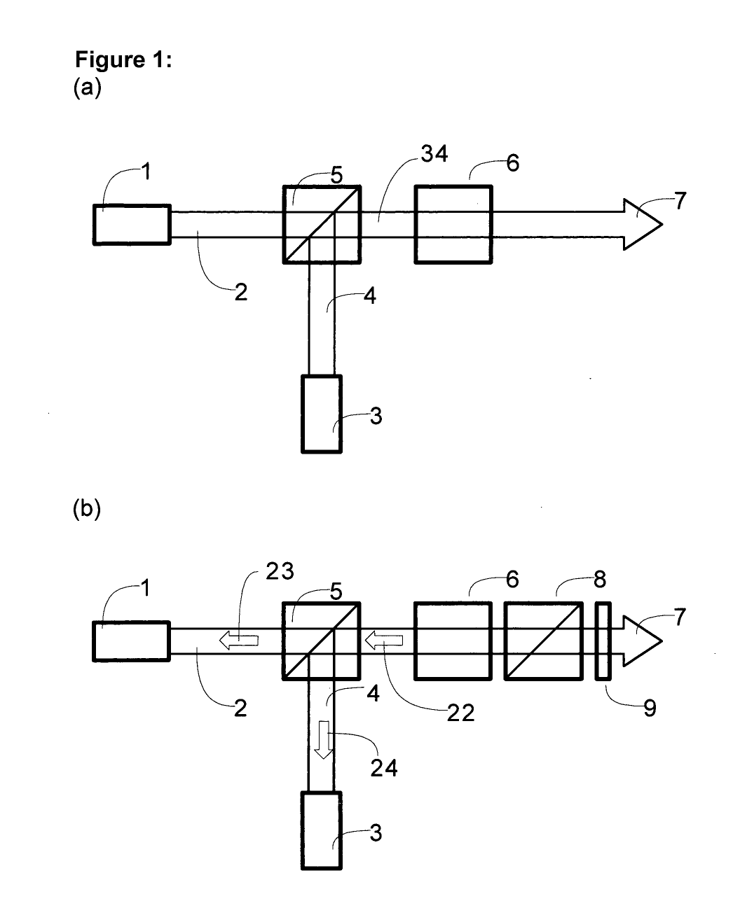

A principal depiction of the assembly is shown in FIG. 1 in sub-figure (a). According to this Figure two beam sources (1) and (3) each emit light (2) and (4) respectively having different wavelengths. This light is preferably orthogonal polarized. The two beams are superimposed by a polarizing beam splitter (5) into a common beam (34). This beam incidents onto a birefringent crystal (6). The birefringence is dispersive which means dependent on wavelength. The optical axis of the birefringent crystal shall be aligned under an inclination of 45° with respect to the polarization of the two beams. This alignment is preferable for retarders and quite common because then the dispersively birefringent crystal acts as a wave plate and directly influences the orientation of polarization of both beam sources. Thanks to the dispersion it is possible to choose such a thickness of the crystal that it acts as a half-wave plate for one wavelength and phase-neutral for the other. Concretely the phase retardation for the two beams have to be (2n+1)*π and 2m*π, m and n being natural numbers. The direction of polarization of the first beam will be twisted by 90° upon exit of the crystal, the direction of the second beam will be unchanged. Consequently the light behind element (6) will be linearly polarized (7). Therefore, the light from two such setups could be simply superimposed by another polarizing beam splitter resulting in a fourfold increase in power as compared to a single beam.

For ease of argument linearly polarized light was assumed. But similar setups could be imagined in which the light would be circularly or elliptically polarized at least over certain parts of the optical path.

In reality it is highly desirable that the two wavelengths are not fixed a priori but instead self-adapt to optimal values as a result of a clever assembly of the optical elements. On this behalf two more elements (8) and (9) are added to the setup as drawn in the bottom sub-figure (b). Element (9) is a partly reflective element, for instance a semipermeable mirror. Element (8) is a polarization filter which lets pass only one polarization which here preferably is assumed linear. That part of the light (22) which is reflected by element (9) can again pass the polarizing filter (8). After that it hits the dispersively birefringent element (6). Depending on the wavelength the direction of polarization is twisted more or less upon traversal of element (6) and possibly becomes elliptically polarized. The polarizing beam splitter (5) separates it into the components (23) and (24) towards the beam sources (1) and (3) respectively. If these beam sources exhibit optical amplification then for both sources a self-amplifying feedback loop is closed which leads to an oscillation on exactly those wavelengths that match best the respective filter characteristics comprised of phase plate (6) and polarizer (5) and thus have the least losses per round trip. For each source this filter acts as a Lyot-filter. But for the one source the light (22) returning from the feedback mirror (9) and polarized linearly by filter (8) has to be twisted by 90°. Not so for the other source. Therefore light (23) and light (24) is distinguishable. This can be so only if it differs in wavelength such that element (6) matches the correct birefringence. Consequently the wavelength for sources (1) and (3) are different.

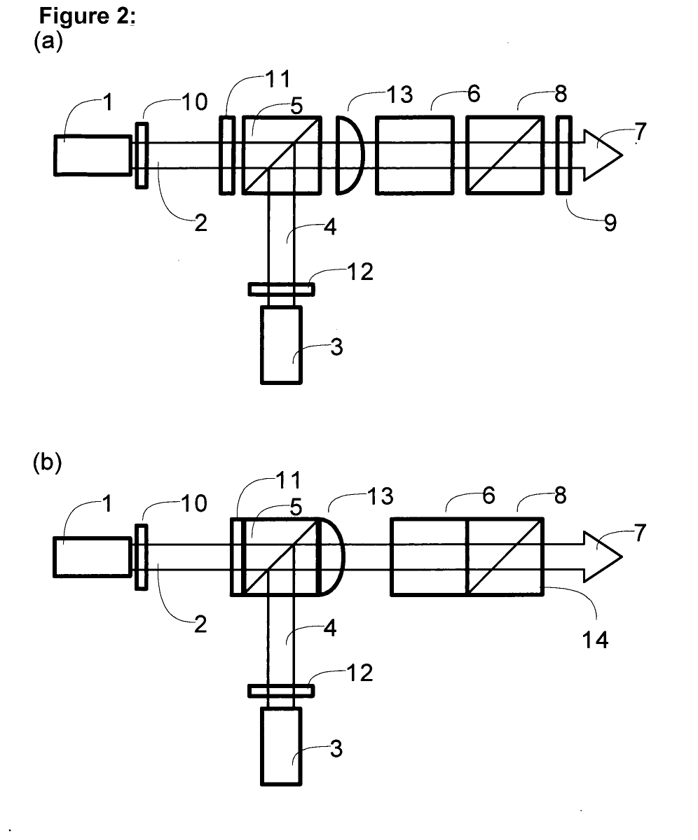

In addition to the elements depicted in FIG. 1 further optical elements are necessary for typical real assemblies: lenses, mirrors, prisms and the like for collimation, imaging, beam guidance etc. For ease of understanding these have not been shown even though they are usually very important for the transverse characteristics of the light (beam waist, divergences, stability, etc.) They belong to the state of the art and exist in large variety. Nonetheless, FIG. 2 depicts a somewhat more elaborate setup. In the upper sub-figure (a) some collimation lenses (10), (12), and (13) for the laser beams are drawn. Also an additional half-wave plate (11) which twists the polarization of one of the beams by 90° can be inserted so that none of the two beam sources needs to be installed in an upright mounting and both sources can be built otherwise identical. This is of particular practical usefulness for diode lasers because they usually possess very different divergences in two orthogonal directions along and perpendicular to their epitaxially defined plane. In this case frequently a very short focal cylindrical lens (10) or (12) (“fast-axis-collimator”) is employed very close to the semiconductor emitter. The collimation along the less divergent direction can then be obtained for multiple beams by one common cylinder lens (13).

The lower sub-figure (b) elaborates a technical improvement: by optically cementing or functionally combining some optical components the overall count of subassemblies can be reduced. For example the partly reflecting mirror (9) can be achieved by a suitable surface coating (14) of one of the surfaces of the polarizer (8). More detailed realizations of combined elements will be given below.

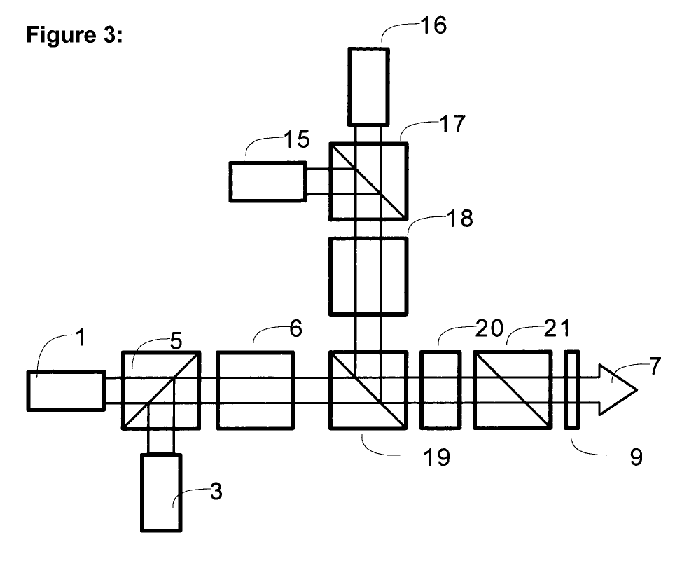

In FIG. 3 is depicted how this procedure can be cascaded by a multi-step filter that has to be passed sequentially by the light. It is important to care about the ratio of thicknesses of the dispersive crystals (6) and (20) or between (18) and (20). They need to be rational like 1:2, 1:3, 1:5, 3:4, etc. This directly follows from the theory of Lyot-filters. Strictly spoken it is not the geometrical thickness but the physical importance is the ratio of the optical birefringence or in other words the optical path differences. If the material and the orientation of the compared crystals is identical then this is proportional to their thicknesses. If different dispersively birefringent crystals are employed their optical path lengths have to be converted accordingly into geometrical thicknesses. Analogously also further steps can be constructed in which each of the coupled lasers of a lower step are in turn coupled without giving up the linear polarization. This case is achievable by replacing the beam sources (1), (2), (15) or (16) by submodules that are themselves already coupled, all while carefully choosing all ratios of thicknesses of the crystals.

### ACHIEVED ADVANTAGES

With conventional polarization coupling it is only possible to superimpose two beams which results in an unpolarized combined beam. Here it becomes possible to re-establish linear polarization. This becomes feasible by active feedback or predefinition of different wavelengths. The invention describes how the light of different beam sources becomes aligned parallel (“rectified”) along a common path along the optical propagation. If need should be this process of rectified polarization coupling can be repeated with the resulting beams. This cascades the number of combined beams in powers of two. As a result much higher total output powers become possible without forfeit in beam diameter, divergence or polarization.

As opposed to known procedures to spectrally multiplex beams by means of gratings or low bandwidth dichroic filters the coupling efficiency is much higher and the spectral distance of wavelengths can be much smaller for same footprints as will be elaborated below.

The damage thresholds of birefringent crystals like calcite or BBO is extraordinarily high and exceeds that of gratings by many orders of magnitude.

Additionally the angle between neighboring beams can be very large due to the orthogonal polarization. For the case of a common polarization beam splitter cube it is 90°. Therefore the different gain regions can be almost freely positioned. For an exemplary system which consists of a calcite crystal of a thickness of 1 cm and which operates around a central wavelength of 650 nm the spectral distance between two wavelengths is about 0.08 nm or an odd multiple of that. Even though the filter itself has a size of only a few cm³ it can easily separate the two beams by a few cm. To achieve a spatial separation of only 1 cm for the same wavelength separation of 0.08 nm with a grating of 3000 lines/mm a propagation distance of over 18 m would be necessary. Furthermore, due to the periodicity of the filter characteristic this assembly is not very sensitive to external influences like a drift of the gain curve with the temperature. Instead of increasingly cutting the efficiency of the lasing line, like it is typical for multiplexing with gratings, the laser line can “evade” by changing laser oscillation to a neighboring laser line predefined by the filter. This is particularly advantageous if the beam sources are themselves are “real” lasers whose emission wavelength shall be locked by additional external feedback to specific values. For this two aspects are important: first the periodicity as long as it is smaller than the locking region of the laser because then the filter does not need to be exactly adapted. And second the fact that spectral multiplexing becomes possible for very close wavelengths. The latter enables multiplexing of gain media with a very narrow gain bandwidth like Nd:YAG which has only 0.5 nm.

As opposed to coherent coupling this kind of multiplexing is tolerant against failure of single gain elements. As all single gaing elements oscillate independently and on separate wavelengths the failure of a single element does not influence the other lasers. Output power decreases only by the amount of the damaged laser but does not cease completely.

### FURTHER ARRANGEMENTS OF INVENTION

The invention can be applied to arbitrary laser materials. Particularly advantageous are semiconductors and all gain media with a sufficient broad gain curve.

If the beam sources deliver themselves sufficiently precise wavelengths to pass the respective Lyot-filter then the final polarization filter can be dispensable.

Presently it appears natural to use beam sources that emit linearly polarized light and that the birefringent crystals are oriented under 45° with their optical axis against the polarization. Then a half-wave retarder twists the polarization by 90°. But the claims shall explicitly not exclude different cases and configurations. For example circularly or elliptically polarized light or different angles could be advantageous. At least along certain parts of the optical path, for example inside the dispersively birefringent crystals, elliptical polarizations occur, so that these characteristics are implicitly contained in the invention. Therefore, they are not elaborated in closer detail because they can be developed by technicians and experts in the field. The entrance and exit surfaces of the optical elements are preferably coated with anti-reflective layers to avoid additional “parasitic” laser resonators. For the case of active wavelength coupling of diode lasers this particularly applies to the outcoupling facet of the semiconductor chip. For a sufficiently dense wavelength spacing this AR-coating on the semiconductor chip can be dispensable if the additional feedback through the Lyot-filters suffices to lock the wavelengths.

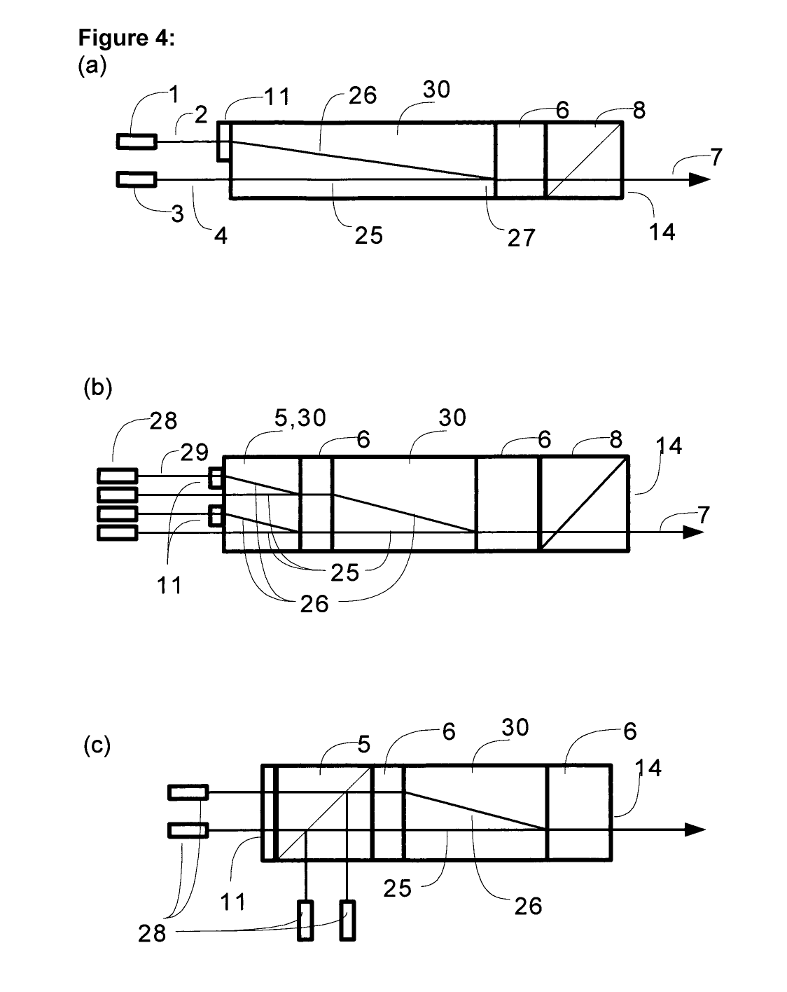

A very compact assembly is depicted in FIG. 4 in different variants (a) through (c). In all of them a so-called “displacer” acts as polarizing beam splitter. This, too, is a birefringent crystal, typically a calcite, which is cut in a way that the directions of propagation for the ordinary (25) and the extraordinary (26) light form an angle. Therefore the two polarizations can be separated or recombined easily. A twist of polarization does not take place. In sub-figure (a) two such sources (1) and (3), that are assumed to be collimated and one possibly rotated by a half-wave plate (11), are aligned parallel. The beams (2) and (4) enter the polarization beam splitter (30). The ordinary rays (25) and the extraordinary rays (26) meet in point (27) where the displacer crystal ends and the dispersively birefringent crystal (6) starts. If needed, an additional polarization filter (8) with suitably reflective surface (14) takes care for feedback so that all wavelengths self-adapt.

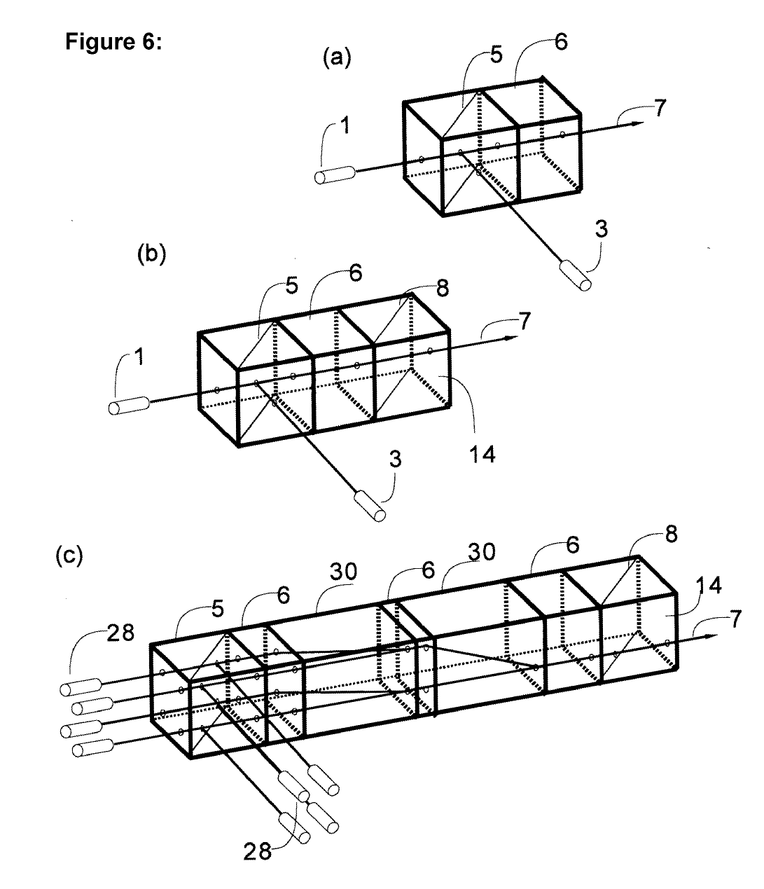

Sub-figure (b) depicts how this assembly can be extended to four beam sources (28). In addition to the variant of sub-figure (a) it takes two displacers (30) and two dispersively birefringent crystals (6) whose lengths are adjusted to one another and to the transverse distances between the beam sources (28). This assembly is particularly advantageous if the beam sources comprise the emitters of a bar of semiconductor lasers. Sub-figure (c) depicts a variant which combines a “regular” polarization beam splitter (5) and a displacer (30) to also combine four beam sources (28). Further combinations comprising different polarization beam splitters—Wollaston-prisms, Taylor-prisms or the like—are simple to construct from the given. The same holds for higher cascading steps to multiplex more than four beam sources. For example it could be advantageous for a cascaded combination of beam sources by means of displacers to arrange the sources in a 2D array and rotate some displacers by 90° around the direction of propagation (c.f. FIG. 6c).

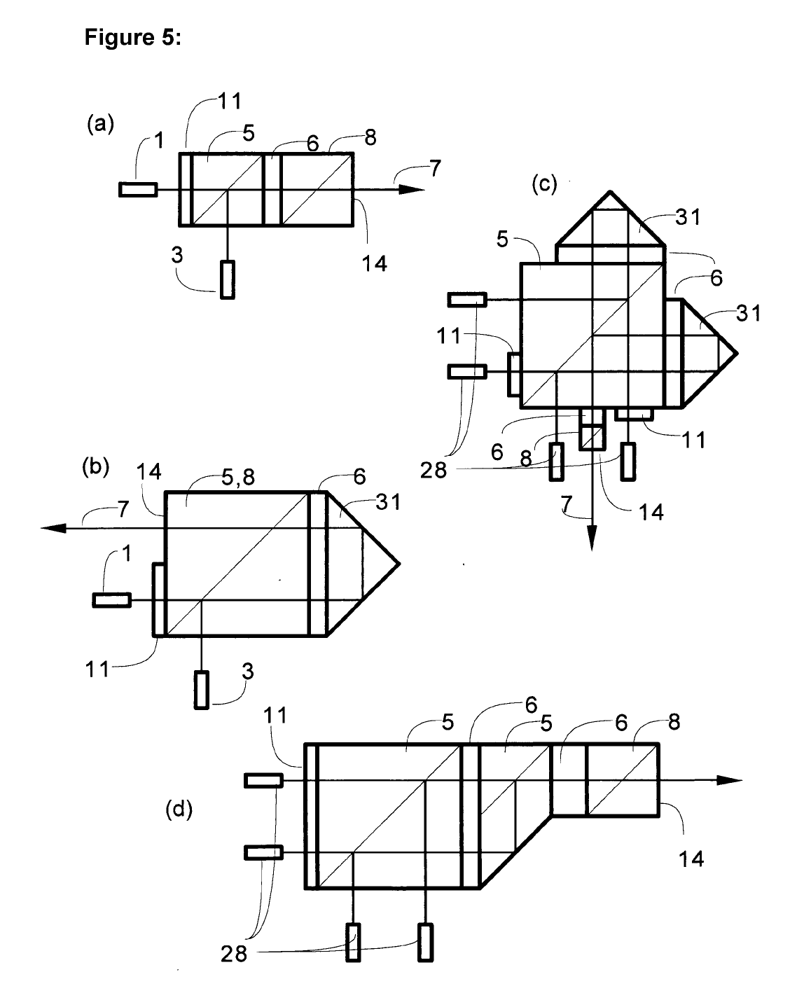

If the beam sources are collimated or at least almost collimated so that a multitude of components can be traversed without an additional collimation there are some more advantageous assemblies according to FIG. 5. In these the optical elements are cemented on their preferably planar surfaces. In some cases like in sub-figures (b) and (c) it is even possible to traverse single components by help of retro-prisms (31) which further reduces the number of components and thus also size and cost.

An extension to more beams, possibly by making use of multiple layers of beams is easily created by experts. Partly this is sketched in FIG. 6 in two pseudo-stereoscopic drawings. Sub-figure (a) depicts the fundamental mechanism of coupling according to the state of the art. In sub-figure (b) two feedback-sensitive beam sources are coupled actively by means of a combination of two polarization beam splitters and one embedded dispersively birefringent crystal. In sub-figure (c) this setup is augmented by two crossed displacers and two more dispersively birefringent crystals to superimpose a total of eight beam sources while maintaining beam propagation factors and polarization.

An interesting application of these spectrally coupled sources results in the high frequency beats in the outcoupling beam that results from interference of two beams with close center wavelengths. The beat note equals half the frequency difference of the two wavelengths. If this light is used for frequency doubling in nonlinear crystals the intensity of the resulting sum frequency light as compared to a single pump laser should be more than double. This results from the quadratic dependence of conversion efficiency with intensity which leads to an overcompensation of the conversion efficiency during constructive interference to those of destructive interference.

If, furthermore, the different wavelengths, at least over certain periods, possess fixed phase differences as can be induced by saturable absorbers or nonlinear indexes of refraction or a modulation of the pump processes, beat notes result that lead to short pulses.

Another interesting application can result from the fact that it is possible to place multiple narrow bandwidth lasers spectrally very close to one another. If these laser lines are then applied in turn to spectral measurements like absorption, it becomes possible to precisely detect slopes, shoulder and closely placed spectral lines without the need to continuously tune the lasing wavelength.

The dispersively birefringent crystal can be made from a variety of materials. Typical materials are calcite, BBO, LiNbO, Quartz etc. Of importance is not so much the absolute difference in index of refraction for the two polarizations but rather how much this difference changes with wavelength. In a certain sense this crystal is the opposite of a zero order waveplate: it shall possess as many wavelengths optical path difference as possible and this difference shall change quickly with changing wavelength.

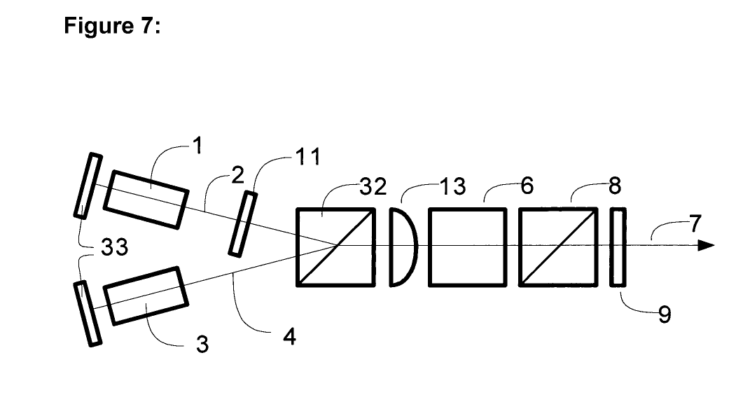

The invention is not only advantageous for semiconductor lasers but also for spectral multiplexing of solid state lasers (c.f. FIG. 7) because for them usually the gain bandwidth is rather narrow (0.5 nm for Nd:YAG). For more than one laserline to fit into this gain bandwidth it is necessary to multiplex with considerably smaller spectral difference. With this invention it becomes possible to scale up also the power of such lasers.

### SHORT DESCRIPTION OF DRAWINGS

### Labels in Figures

(1) first beam source
(2) light from first beam source
(3) second beam source
(4) light from second beam source
(5) polarization beam splitter
(6) dispersively birefringent element
(7) polarized common exit beam of first and second beam source
(8) polarization filter
(9) semitransparent reflective element
(10) collimation lens for first beam source
(11) polarization rotating element
(12) collimation lens for second beam sources
(13) collimation lens for both beam sources
(14) partly reflective surface coating
(15) third beam source
(16) fourth beam source
(17) polarization beam splitter
(18) dispersively birefringent element
(19) polarization beam splitter
(20) dispersively birefringent element
(21) polarization filter like (8)
(22) light that returns from partly reflecting element to beam sources
(23) light that returns to beam source (1)
(24) light that returns to beam source (3)
(25) ordinary beam of light inside a birefringent crystal
(26) extraordinary beam of light inside a birefringent crystal
(27) common place of ordinary and extraordinary ray of light
(28) multiple beam sources, possibly collimated
(29) multiple beams
(30) birefringent crystal as polarization beam splitter (“displacer”) as special case of (5)
(31) deflecting prism
(32) Wollaston-prism as polarization beam splitter as a special case of (5)
(33) mirror
(34) superimposed beam

### FIG. 1:

### Principal Depiction of the Functionality of the Assemblies.

Two beam sources (1) and (3) which by precondition emit perpendicularly polarized light (2) and (4) are superimposed into a common beam (34) by a polarizing beam splitter (5) and their polarization be rectified (7) by means of a suitably chosen dispersively birefringent crystal (6). An active feedback and thus an automatic adaption of suitable wavelengths can be enforced by means of elements (8) and (9). In this case a fraction (22) of the common beam is sent back as beams (23) and (24) into the respective beam sources.

### FIG. 2:

### A More Realistic Display of the Assemblies.

In the upper half of the figure are depicted collimation lenses (10), (12), and (13) that are typically needed. Also shown is a half-wave plate (11) which twists the polarization of one of the two beams by 90° for ease of setup.

In the lower half of the figure is suggested that multiple optical components can be optically cemented.

### FIG. 3:

Assemblies with Multiple Stages.

It is displayed how this approach can be cascaded by a sequential traversal of multiple stages of filters. On this behalf additional dispersively birefringent crystals (18) and (20) and an additional polarization beam splitter (21) are applied. So, in a first step the beams (15) and (16) are coupled with the splitter (17) and rectified by element (18) analogous to the Elements (1), (3), (5), and (6) respectively. After that the two beams get superimposed by element (19) and are forced to suitable wavelengths through elements (20) and (21) by means of feedback on element (9). Generally each beam source can itself be assembled as a coupled beam source as long as thickness and dispersion of the birefringent elements are selected suitably.

### FIG. 4:

Assemblies in which at least one polarization beam splitter (30) comprises a so-called “displacer” as a special case of a beam splitter (5). Here the ordinary (25) and extraordinary beam (26) propagate in different directions. This opens way for very compact setups which can also comprise multiple stages. If multiple displacers are arranged with their respective optical axis rotated by an angle that is not necessary 90° also two dimensional arrays of multiple beam sources can be combined into a common beam.

### FIG. 5:

Assembly in which multiple beam splitters (5), (8) and/or dispersively birefringent crystals (6) and/or further optical Elements (31) are optically bonded. By this it is possible to realize very compact setups. A further reduction in volume and production cost results from a multiple traversal of some optical components (5), (6), and (8) as is displayed in sub-figures (b) and (c).

### FIG. 6:

### Pseudo-Stereoscopic Drawings.

Sub-figure (a) shows how two preferably collimated beam sources (1) and (2) of suitable polarization and wavelengths can be united into one single polarized beam by means of a polarization beam splitter (5) and a dispersively birefringent crystal (6).

Sub-figure (b) shows how the wavelengths adapt themselves to correct values if the beam sources are sensitive to feedback. This is achieved by an additional polarization filter (8) and a suitably partially reflective surface (14).

Sub-figure (c) displays a possible polarization maintaining coupling of eight beam sources (28) into a common beam (7). Here the polarization beam splitter (5) and (8) and two displacers (30) which are rotated by 90° with respect to one another achieve the coupling. Again, if surface (14) is suitably partially reflective, the wavelengths can adapt themselves to optimal values.

### FIG. 7:

### Use of Wollaston-Prisms.

FIG. (7) shows how two lasers can be spectrally coupled by means of a Wollaston-prism (32). This is a particularly good choice for solid state lasers like Nd:YAG-lasers. For them it is usually necessary to utilize a highly reflective mirror (33) to close the laser resonators on their back end. If the used lasing crystal does not have a preferred polarization the use of half-wave retarders (11) can be dispensed with. With a suitable design of the laser resonators the lens (13) can be used for both lasers at the same time. For the case of thermal lensing inside the active material the lens can also be dispensable completely.

1-12. (canceled)

13. An optical assembly comprising:
(a) two gain media possessing spectrally overlapping gain curves,
(b) a polarizing beam splitter, and
(c) a dispersively birefringent element
where
(d) the polarizing beam splitter superimposes the light of the two gain media and sends it towards the dispersively birefringent element, and
(e) the dispersively birefringent element possesses a different phase retardation for two different wavelengths,
such that
(f) light from a dispersively birefringent element hits a partially reflective mirror which is aligned so that a part of the light returns to the respective gain medium.

14. An optical assembly according to claim 13, such that the light from a dispersively birefringent element traverses another polarization filter before it hits the partially reflective mirror.

15. An optical assembly according to claim 13, such that
(a) one of the mentioned dispersively birefringent elements operates as a different phase retarder for two different wavelengths and
(b) the difference of the total retardations of both wavelengths along their respective optical paths is essentially λ/2.

16. An optical assembly according to claim 15, such that
(a) the gain media emit linearly polarized light and
(b) the optical axis of the dispersively birefringent element is inclined by 45° with respect to the direction of the linear polarization.

17. An optical assembly according to claim 13, such that one of the beam sources itself is set up according the previous claims.

18. An optical assembly according to claim 17, such that the ratios between the optical thicknesses of the dispersively birefringent elements which are traversed by the beams have essentially rational ratios.

19. An optical assembly according to claim 13, such that mirrors and/or prisms guide the beams in a way that one of the polarizing beam splitters or one of the dispersively birefringent elements is traversed at different positions on the way from the gain medium to the partly reflective mirror.

20. An optical assembly according to claim 18, such that the multiple traversal of a beam from the gain medium to the partly reflective element through the dispersively birefringent element accounts for the condition of rational ratio of the thicknesses.

21. An optical assembly according to claim 13, such that the common beam additionally traverses a nonlinear optical element.

22. An optical assembly according to claim 21, such that the nonlinear optical element is located inside the laser resonator.

23. An optical assembly according to claim 13, such that the common beam is used for spectroscopic applications in a narrow spectral region.

24. An optical assembly according to claim 21, such that the nonlinear element emphasizes or enforces a fixed phase relation between different wavelengths.

25. An optical assembly according to claim 24, such that the beams of different wavelength possess a constant phase relation for a duration of time so that high frequency beats or short pulses result.
